(19) United States
(12) Patent Application Publication
(10) Pub. No.: US 2017/0299064 A1
(43) Pub. Date: Oct. 19, 2017

(54) Plumbing Fixture Fluid Diversion Assembly

(71) Applicant: Hassan Zock-Obregon, Miami, FL (US)

(72) Inventor: Hassan Zock-Obregon, Miami, FL (US)

(21) Appl. No.: 15/131,280

(22) Filed: Apr. 18, 2016

(51) Int. Cl. F16K 1/20; F16K 31/12; F16K 31/06; F16K 31/46; E03C 1/04

(52) U.S. Cl. CPC F16K 1/2007; F16K 31/465; E03C 1/04; F16K 31/0655; F16K 31/12

(57) ABSTRACT

A plumbing fixture fluid diversion assembly minimizes dripping from an outlet conduit of a spout body by restricting passage of accumulated fluid through the outlet conduit. The assembly comprises a hollow spout body having an inlet conduit that carries fluid to a diversion chamber. The diversion chamber is in communication with the inlet conduit and the outlet conduit. A routing notch helps control the flow of the fluid towards a chamber opening that is disposed between the diversion chamber and the outlet conduit. The chamber opening enables passage of fluid to the outlet conduit. A flap selectively covers and uncovers the chamber opening to control dripping from the outlet conduit. The assembly generates an initial force to at least partially urge the flap towards the chamber opening for covering by pulling a cable, displacing magnet proximal to the flap, or creating a vacuum to displace the flap.

### FIELD OF THE INVENTION

The present invention relates generally to a plumbing fixture fluid diversion assembly that minimizes dripping from an outlet conduit of a spout body by restricting passage of accumulated fluid from the outlet conduit, so as to divert the fluid to an elevated fluid discharge outlet. More so, a plumbing fixture fluid diversion assembly provides an effective means for permitting an elevated fluid discharge outlet to receive the excess flow of fluid from a spout body by restricting and diverting the fluid that accumulates and drips from an outlet conduit; whereby the assembly provides a hollow spout body encapsulating an inlet conduit, an outlet conduit, and a diversion chamber; a diversion chamber that is disposed between, and in communication with the inlet conduit and the outlet conduit and configured to receive an incoming fluid from the inlet conduit; a chamber opening disposed between the diversion chamber and the outlet conduit; a flap that is configured to selectively open and close over the first chamber opening, so as to regulate fluid flow to the outlet conduit; whereby covering the chamber opening with the flap helps divert excess fluid accumulation and drippings from the outlet conduit to the elevated fluid discharge outlet; whereby the flap is triggered to selectively cover the chamber opening through at least one of the following means: a mechanical pulling action that at least partially urges the flap towards the first chamber opening; a magnet that at least partially urges the flap towards the first chamber opening; and a pressure chamber adjacent to the diversion chamber that creates sufficient pressure that at least partially urges the flap towards the first chamber opening.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Typically, a bathtub is a large container for holding water in which a person may bathe or shower if a shower head is attached. Most bathtubs are made of acrylic or fiberglass, but alternatives are available in enamel on steel or cast iron. A filler spout often extends from the bathtub to fill the tub with water. Often the spout must divert excess water from the spout to the shower head when switching to a showering function.

It is known that many types of bathtub diverter spouts have been used to provide an effective means for bypassing the filler spout and carrying the water to the shower head. This is often accomplished by pulling up a lever located near the filler spout. However, spout diverters often have a problem of constant water dripping from the spout opening while in operation (during taking a shower) diverting water to the shower head.

Often, an internal mechanical flap, leaver or ball which when moved, diverts water from the spout opening to the shower head. These diversion spouts all however have the same problem of dripping because when the water is diverted, the flap does not completely close the flap opening which directs the water to the spout opening, and hence it keeps dripping while in operation.

The closure of the flap opening and prevented dripping involves automatically releasing the trapped water in the pipe when the water is shut off. Thus, a balance between reducing the dripping while in operation (diverting water from the spout to the shower head) and water release after water shut off (emptying the water in the pipe) must occur.

It is known that there is a diverting spout which releases trapped water after use, but still drips while in operation. It becomes acceptable in the practical market that a little dripping is acceptable as long as the problem of water release is solved, because the latter seems to be more of a concern to avoid cold-water shocks when the shower is used again, than saving the water from dripping.

Other proposals have involved diverting excess water from a bathtub spout. The problem with these plumbing fixtures is that they have the same problem of excessive dripping because when the water is diverted, the flap does not completely close the flap opening which directs the water to the spout opening, and hence it keeps dripping while in operation. Even though the above cited diverting plumbing fixtures meet some of the needs of the market, a plumbing fixture fluid diversion assembly that minimizes dripping from an outlet conduit of a spout body by restricting passage of accumulated fluid from the outlet conduit, so as to divert the fluid to an elevated fluid discharge outlet is still desired.

### SUMMARY OF THE INVENTION

The present invention is directed to a plumbing fixture fluid diversion assembly that minimizes fluid accumulation and dripping from an outlet conduit by selectively regulating passage of accumulated fluid through the outlet conduit, so as to divert the fluid to an elevated fluid discharge outlet without dripping fluid from an outlet conduit. The plumbing fixture fluid diversion assembly, hereafter “assembly”, provides an effective means for permitting an elevated fluid discharge outlet to receive the excess fluid that accumulates in a spout body by diverting the fluid that accumulates and drips from a spout body, such as a bathtub spout, to the elevated fluid discharge outlet. The assembly is unique in that multiple mechanical means, such as a cable, a magnet, and a pressure chamber may be used to regulate the flow of fluid through the outlet conduit, so as to restrict dripping during operation of the elevated fluid discharge outlet.

In one aspect, the plumbing fixture diversion assembly, comprises:
an inlet conduit, the inlet conduit configured to enable carrying a fluid;
a diversion chamber, the diversion chamber configured to be in communication with the inlet conduit, the diversion chamber further configured to receive the fluid from the inlet conduit, whereby a substantial volume of the diversion chamber is configured to be filled with the fluid, the diversion chamber comprising a chamber opening;
an outlet conduit, the outlet conduit configured to be in communication with the diversion chamber through the chamber opening, the outlet conduit further configured to discharge the fluid received from the diversion chamber;
a flap, the flap configured to be at least partially fabricated from a metal, the flap further configured to selectively cover and uncover the chamber opening, the flap further configured to require an initial force to at least partially urge the flap towards the chamber opening for covering the chamber opening,
whereby, after the initial force is applied to the flap, the fluid fills a substantial volume of the diversion chamber, creating sufficient fluid pressure in the diversion chamber to displace the flap to cover the first chamber opening,
whereby, after the diversion chamber is filled to a substantial volume with the fluid, the fluid is restricted from flowing into the diversion chamber, causing fluid pressure in the diversion chamber to decrease, causing the flap to disengage and uncover the chamber opening;
a cable, the cable defined by a first end and a second end, the first end of the cable configured to operatively join with the flap, the second end of the cable configured to hang freely from the outlet conduit, the cable configured to apply the initial force to the flap that at least partially urges the flap towards the chamber opening;
a magnet, the magnet configured to be displaced proximally to the flap, the proximal positioning between the magnet and the flap generating a magnetic force, the magnet force operable to at least partially urge the flap towards the chamber opening; and
a pressure chamber, the pressure chamber disposed in communication with the diversion chamber through at least one pressure hole, the pressure chamber configured to generate a vacuum by covering and uncovering the at least one pressure hole, the vacuum operable to at least partially urge the flap towards the chamber opening.

In another aspect, the assembly comprises a generally hollow body spout, the body spout configured to encapsulate the inlet conduit, the diversion chamber, and the outlet conduit.

In another aspect, the hollow body spout comprises a bathtub spout.

In yet another aspect, the outlet conduit comprises an opening for the bathtub spout.

In yet another aspect, the inlet conduit comprises a pipe having a pipe thread.

In yet another aspect, the inlet conduit is configured to operatively connect to an elevated fluid discharge outlet.

In yet another aspect, the assembly further comprises a second chamber opening, the second chamber opening disposed adjacent to, and in communication with the chamber opening and the outlet conduit.

In yet another aspect, the flap is hingedly connected to the diversion chamber.

In yet another aspect, the assembly further comprises a flap compartment.

In yet another aspect, the flap is configured to position in the flap compartment when fully disengaged and uncovering the chamber opening.

In yet another aspect, the assembly further comprises a routing notch, the routing notch configured to direct the fluid towards the chamber opening.

In yet another aspect, the cable comprises a chain.

In yet another aspect, the second end of the cable comprises a ring.

In yet another aspect, the magnet comprises a spring-biased button, the spring-biased button configured to selectively displace the magnet proximally and distally in relation to the flap.

In yet another aspect, the pressure chamber further comprises a check valve.

In one embodiment, the assembly comprises a hollow spout body that substantially encapsulates an inlet conduit and an outlet conduit. The inlet conduit carries the fluid to the outlet conduit. A diversion chamber is disposed in the spout body. The diversion chamber is in communication with the inlet conduit and the outlet conduit. The diversion chamber is configured to receive the incoming fluid from the inlet conduit. A routing notch helps control the flow of the fluid towards a chamber opening that is disposed between the diversion chamber and the outlet conduit. The fluid may flow from the inlet conduit, through the diversion chamber, through the chamber opening, before finally discharging fluid through the outlet conduit.

A flap is provided to selectively regulate the flow of the fluid towards the outlet conduit. The flap controllably opens and closes over the chamber opening, so as to regulate fluid flow to the outlet conduit. Thus, when the chamber opening is substantially covered by the flap, dripping by the outlet conduit is restricted as the fluid is either retained inside the diversion chamber, or diverted to flow towards the elevated fluid discharge outlet. Thus, by covering the chamber opening with the flap, the fluid is restricted from dripping from the outlet conduit.

The flap is triggered to selectively cover the chamber opening by an initial force that is actuated through a mechanical mechanism. The initial force works to at least partially urge the flap towards the chamber opening. Once the flap is partially urged towards the first chamber opening, the incoming fluid fills a substantial volume of the diversion chamber, creating sufficient fluid pressure to buoy the flap into complete engagement with the first chamber opening. In one embodiment, the flap is hingedly configured, so as to pivot towards and away from the chamber opening. A flap compartment may receive the flap when the flap is fully disengaged from the chamber opening.

The assembly, thus provides the trigger to urge the flap towards the chamber opening in the form of an initial force. Once the flap has commenced being displaced towards the chamber opening, the incoming flow of fluid continues the displacement of the flap towards complete engagement (covering) of the chamber opening.

Conversely, when the fluid is restricted from flowing into the diversion chamber, the fluid pressure decreases in the diversion chamber, and the flap drops away from the chamber opening and into the flap compartment under its own weight. The fluid may then drain from the outlet conduit since the chamber opening is open. In this manner, the fluid that accumulates in an elevated conduit leading to the elevated fluid discharge outlet is effectively drained. And thus, cold fluid does not initially dispense from the elevated fluid discharge outlet when the fluid commences flowing.

As discussed above, the flap is initially triggered with an initial force towards the chamber opening. After the flap commences movement towards the chamber opening, the substantial volume of fluid accumulation in the diversion chamber buoys the flap into full engagement with the chamber opening. In one embodiment, a cable may extend from the flap to outside the outlet conduit. The cable may be pulled away from the outlet conduit to at least partially urge the flap towards the first chamber opening.

In another embodiment, the flap comprises a metal composition. In this configuration, a magnet is disposed proximal to the flap. A spring-biased button may be used to displace the magnet towards the flap, so as to create a magnetic force therebetween. The magnetic force is effective for at least partially urging the flap towards the first chamber opening.

In yet another mechanical means for triggering the initial motion of the flap, a pressure chamber is used. The pressure chamber is disposed adjacent to, and in communication with the diversion chamber. A pressure may be manufactured in the pressure chamber that creates sufficient pressure to at least partially urge the flap towards the first chamber opening. Again, as the flap is initially triggered towards the chamber opening, the increasing fluid pressure in the diversion chamber urges the flap into complete engagement with the chamber opening; thus restricting dripping from the outlet conduit.

It is significant to note that the cable, the magnet, and the pressure chamber may be used in conjunction with each other, separately from each other, or in any combination. These mechanisms perform substantially the same function, but provide different levels of ease and comfort in their operation.

It is one objective of the present invention to provide a diversion assembly that restricts excessive dripping at a bathtub spout when the water is diverted to a shower head.

It is another objective to provide a drip-free diverter mechanism that allows water to divert from a bathtub spout to a shower head without dripping water from the bathtub spout.

It is another objective to leverage the water pressure in the diverting chamber to push the flap in the same direction against the chamber opening which directs water to the outlet conduit.

Yet another objective is to provide a simple initial force to at least partially urge the flap towards the chamber opening for covering the chamber by pulling a cable, displacing magnet proximal to the flap, or creating a simple vacuum by blocking water coming from the spout opening.

Yet another objective is to provide a means for releasing trapped water in the pipe when the water flow is terminated.

Yet another objective is to provide an adaptable diversion assembly that can be used universally with bathtubs, sinks, and other plumbing fixtures.

Yet another objective is to provide an inexpensive to manufacture plumbing fixture fluid diversion assembly.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a sectioned side view of an exemplary plumbing fixture fluid diversion assembly, showing a cable and a magnet for regulating a flap, in accordance with an embodiment of the present invention; and

FIG. 2 illustrates a sectioned side view of the plumbing fixture fluid diversion assembly of FIG. 1, showing a pressure chamber for regulating the flap, in accordance with an embodiment of the present invention.

Like reference numerals refer to like parts throughout the various views of the drawings.

### DETAILED DESCRIPTION OF THE INVENTION

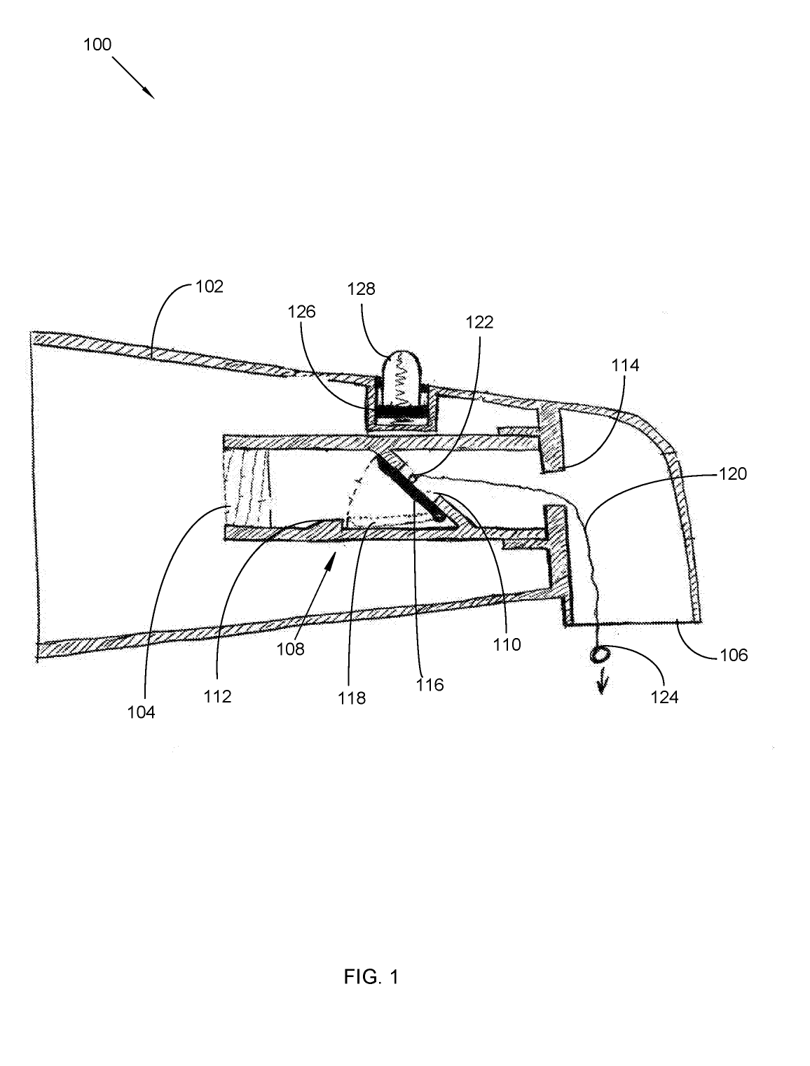

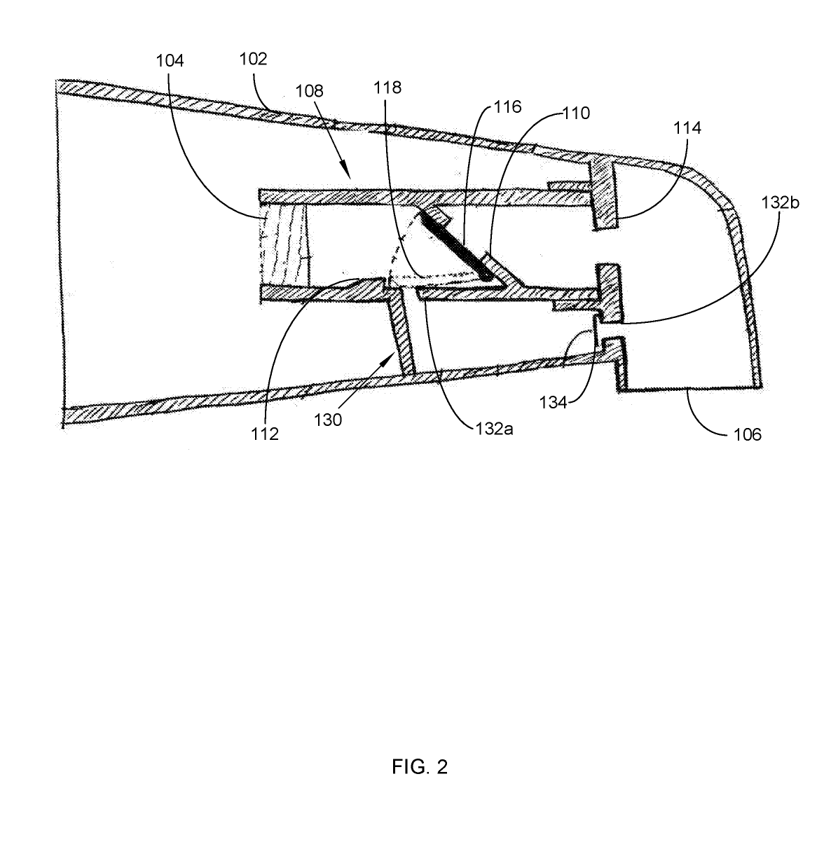

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1 and FIG. 2. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

FIGS. 1-2 illustrate exemplary embodiments of a plumbing fixture fluid diversion assembly 100 configured to minimize fluid accumulation and dripping from an outlet conduit 106 by selectively regulating passage of accumulated fluid through the outlet conduit 106, so as to divert the fluid to an elevated fluid discharge outlet (not shown) without dripping fluid from an outlet conduit 106. The plumbing fixture fluid diversion assembly 100, hereafter “assembly 100”, provides an effective means for permitting the elevated fluid discharge outlet, such as a shower head, to receive the diverted fluid that accumulates and drips from the spout body 102. The assembly 100 also drains the accumulated fluid so as to minimize excessively cold fluid from initially discharging from the elevated fluid discharge outlet. The assembly 100 is unique in that multiple mechanical means, such as a cable 120, a magnet 126, and a pressure chamber 130 may be used to regulate the flow of fluid through the spout body 102, so as to restrict dripping through the outlet conduit 106.

As referenced in FIG. 1, the assembly 100 comprises a hollow spout body 102 that substantially encapsulates an inlet conduit 104 and an outlet conduit 106. The spout body 102 may include a bathtub spout. Though the assembly 100 is adaptable with a sink, a shower, and other plumbing fixtures. In one possible embodiment, the body spout is defined by a round open attaching end tapering to a downward extending spout discharge opening and a top surface therebetween. Though other shapes and dimensions of spouts may be used.

The inlet conduit 104 carries the fluid through the spout body 102 to a diversion chamber 108 before an outlet conduit 106 discharges the fluid. The inlet conduit 104 may include a pipe having a threaded terminus. In one embodiment, the inlet conduit 104 is configured to operatively connect to an elevated fluid discharge outlet, such as a shower head. The outlet conduit 106 may form an opening at the terminus of the spout body 102. The fluid flow through the outlet conduit 106 is regulated, so as to minimize dripping when diverting fluid to the elevated fluid discharge outlet.

In some embodiments, the diversion chamber 108 is disposed within the spout body 102. The diversion chamber 108 is in communication with the inlet conduit 104 and the outlet conduit 106. The diversion chamber 108 is configured to receive the incoming fluid from the inlet conduit 104. A routing notch 112 helps control the flow of the fluid towards a chamber opening 110 that is disposed between the diversion chamber 108 and the outlet conduit 106. The fluid may flow from the inlet conduit 104, through the diversion chamber 108, through the chamber opening 110, before finally discharging fluid through the outlet conduit 106. In some embodiments, a second chamber opening 114 is disposed adjacent to, and in communication with the chamber opening 110 and the outlet conduit 106.

In one embodiment, as a substantial volume of the diversion chamber 108 is filled with fluid, pressure builds up inside the diversion chamber 108. As discussed below, the pressure build up and pressure release in the diversion chamber 108 helps regulate a flap 116. The flap 116 is configured to selectively regulate the flow of the fluid flowing through the outlet conduit 106. Specifically, the flap 116 controllably covers and uncovers the chamber opening 110, so as to regulate fluid flow to the outlet conduit 106. In one embodiment, the flap 116 hingedly moves to cover and uncover the chamber opening 110. The flap 116 may also be sufficiently buoyant, such that the fluid level in the diversion chamber 108 may displace the flap 116 towards the chamber opening 110. The weight of the flap 116 may also work to drop the flap 116 away from the chamber opening 110 when insufficient fluid pressure is available to support the flap 116.

Thus, when the chamber opening 110 is substantially covered by the flap 116, dripping by the outlet conduit 106 is restricted as the fluid is either retained inside the diversion chamber 108, or diverted to flow towards the elevated fluid discharge outlet. Thus, by covering the chamber opening 110 with the flap 116, the fluid is restricted from dripping from the outlet conduit 106. The flap 116 may include a generally planar member that is at least partially fabricated from metal.

The flap 116 is triggered to selectively cover the chamber opening 110 by an initial force that is actuated through a mechanical mechanism. The initial force works to at least partially urge the flap 116 towards the chamber opening 110. Once the flap 116 is partially urged towards the first chamber opening 110, the incoming fluid fills a substantial volume of the diversion chamber 108, creating sufficient fluid pressure to displace, or buoy the flap 116 into complete engagement with the first chamber opening 110. This, in essence covers the chamber opening 110. FIGS. 1 and 2 both show the flap 116 in the fully engaged covering position over the chamber opening 110.

In some embodiments, the flap 116 may be hingedly configured, so as to pivot towards and away from the chamber opening 110. A flap compartment 118 may receive the flap 116 when the flap 116 is fully disengaged from the chamber opening 110. The flap compartment 118 may be sized and dimensioned slightly larger than the flap 116, so as to allow free movement thereof.

The assembly 100, thus provides the trigger to urge the flap 116 towards the chamber opening 110 in the form of an initial force. Once the initial force has initiated displacement of the flap 116 towards the chamber opening 110, the incoming flow of fluid builds pressure in the diversion chamber 108 to continue the displacement of the flap 116 towards complete engagement (covering) of the chamber opening 110.

Conversely, when the fluid is restricted from flowing into the diversion chamber 108, the fluid pressure decreases in the diversion chamber 108, and the flap 116 drops away from the chamber opening 110 and into the flap compartment 118 under its own weight. The fluid may then drain from the outlet conduit 106 since the chamber opening 110 is open. In this manner, the fluid that accumulates in an elevated conduit leading to the elevated fluid discharge outlet is effectively drained. And thus, cold fluid does not initially dispense from the elevated fluid discharge outlet when the fluid commences flowing.

As discussed above, the flap 116 is initially triggered with an initial force towards the chamber opening 110. After the flap 116 commences movement towards the chamber opening 110, the substantial volume of fluid accumulation in the diversion chamber 108 lifts or buoys the flap 116 into full engagement with the chamber opening 110.

In one embodiment illustrated in FIG. 1, the initial force may be actuated through a cable 120. The cable 120 may include a first end 122 and a second end 124. The first end 122 may join with the flap 116. The second end 124 may hang freely outside the outlet conduit 106 in such a manner that gripping access to the cable 120 is possible. The cable 120 may be pulled away from the outlet conduit 106 to at least partially urge the flap 116 towards the first chamber opening 110. In one embodiment, a slight tugging force is sufficient to apply the initial force to the flap 116. In one embodiment, the cable 120 is a chain and the second end 124 comprises a ring for enhancing the grip of the cable 120.

In another embodiment shown in FIG. 1, the initial force may be actuated through a magnet 126. As discussed above, the flap 116 is fabricated at least partially, from a metal composition. In this configuration, the magnet 126 may be selectively displaced proximal and distal relative to the flap 116. A switch, such as a spring-biased button 128 may be used to displace the magnet 126 proximally towards the flap 116, so as to create a magnetic force therebetween. The magnetic force is effective for at least partially urging the flap 116 towards the first chamber opening 110. Conversely, the magnet 126 may be displaced distally from the flap 116 until the initial force is required.

As FIG. 2 illustrates, the initial force may also be actuated through use of a pressure chamber 130. The pressure chamber 130 is disposed adjacent to, and in communication with the diversion chamber 108. At least one pressure hole 132a, 132b is used to generate a vacuum in the pressure chamber 130 and the diversion chamber 108.

In one exemplary embodiment of the at least one pressure hole 132a, 132b, two pressure controlling holes are configured to create a pressure differential. The pressure differential causes the flap 116 to rise up. When the flap 116 is down and water normally flows through the diversion chamber 108 and freely out of spout opining 106, the pressure in the pressure chamber 130 is low, and the flap 116 remains down. When the user blocks the spout opening 106 with his hand, the water is forced to escape into the pressure chamber 130 via the hole 132b and the check valve 134.

This pressure buildup into the camber 130 creates a water pulse to escape the chamber 130 through hole 132a into the diversion chamber 108. This water pulse urges the flap 116 up enough to get caught against the water flow in the chamber 108, which causes the flap 116 to be push further in the direction the water flow until the flap 116 closes against the camber opening 110. This prevents water form flowing out of the spout. Consequently, the water may flow through hole 132a into the pressure chamber. And once the pressure chamber builds enough pressure, the check valve 134 will stop the water flow.

It is significant to note that as long as the water maintains pressure in the diversion chamber 108, water is prevented to flow out of the spout neither form opening 110 nor from opening 132b, and thus complete blockage of water occurs. When water shuts off from the main valves, and there is insufficient water pressure in the diversion chamber 108, the flap 116 drops down on its own due to its weight.

In one embodiment, the at least one pressure hole 132a, 132b of the pressure chamber 130 comprises a first pressure hole 132a beneath the flap 116, and a second pressure hole 132b adjacent to the chamber opening 110. Selective covering of the pressure hole 132a, 132b creates the vacuum. A check valve 134 between the pressure chamber 130 and the pressure hole 132b and outlet conduit 106 may help regulate the flow of fluid and air pressure to and from the pressure chamber 130.

It is significant to note that the cable 120, the magnet 126, and the pressure chamber 130 may be used in conjunction with each other, separately from each other, or in any combination for operation of the assembly 100. These mechanisms perform substantially the same function, but provide different levels of ease and comfort in their operation.

In review, as the flap 116 is initially triggered towards the chamber opening 110, the increasing fluid pressure in the diversion chamber 108 urges the flap 116 into complete engagement with the chamber opening 110; thus restricting dripping from the outlet conduit 106. As the pressure buildup reaches saturation in the diversion chamber 108, the pressure decreases, and the flap 116 falls back away from the chamber opening 110. This causes the fluid to drain from the outlet conduit 106. Thus, the flap 116 is designed to move between two positions, either completely resting in the flap compartment 118, or completely covering the chamber opening 110.

These and other advantages of the invention will be further understood and appreciated by those skilled in the art by reference to the following written specification, claims and appended drawings.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What I claim is:

1. A plumbing fixture diversion assembly, the assembly comprising:
an inlet conduit, the inlet conduit configured to enable carrying a fluid;
a diversion chamber, the diversion chamber configured to be in communication with the inlet conduit, the diversion chamber further configured to receive the fluid from the inlet conduit, whereby a substantial volume of the diversion chamber is configured to be filled with the fluid, the diversion chamber comprising a chamber opening;
an outlet conduit, the outlet conduit configured to be in communication with the diversion chamber through the chamber opening, the outlet conduit further configured to discharge the fluid received from the diversion chamber;
a flap, the flap configured to be at least partially fabricated from a metal, the flap further configured to selectively cover and uncover the chamber opening, the flap further configured to require an initial force to at least partially urge the flap towards the chamber opening for covering the chamber opening,
whereby, after the initial force is applied to the flap, the fluid fills a substantial volume of the diversion chamber, creating sufficient fluid pressure in the diversion chamber to displace the flap to cover the first chamber opening,
whereby, after the diversion chamber is filled to a substantial volume with the fluid, the fluid is restricted from flowing into the diversion chamber, causing fluid pressure in the diversion chamber to decrease, causing the flap to disengage and uncover the chamber opening;
a cable, the cable defined by a first end and a second end, the first end of the cable configured to operatively join with the flap, the second end of the cable configured to hang freely from the outlet conduit, the cable configured to apply the initial force to the flap that at least partially urges the flap towards the chamber opening;
a magnet, the magnet configured to be displaced proximally to the flap, the proximal positioning between the magnet and the flap generating a magnetic force, the magnet force operable to at least partially urge the flap towards the chamber opening; and
a pressure chamber, the pressure chamber disposed in communication with the diversion chamber through at least one pressure hole, the pressure chamber configured to generate a vacuum by covering and uncovering the at least one pressure hole, the vacuum operable to at least partially urge the flap towards the chamber opening.

2. The assembly of claim 1, wherein the assembly comprises a generally hollow body spout, the body spout configured to encapsulate the inlet conduit, the diversion chamber, and the outlet conduit.

3. The assembly of claim 2, wherein the body spout comprises a bathtub spout.

4. The assembly of claim 3, wherein the outlet conduit comprises an opening for the bathtub spout.

5. The assembly of claim 1, wherein the inlet conduit comprises a pipe having a pipe thread.

6. The assembly of claim 1, wherein the inlet conduit is configured to operatively connect to an elevated fluid discharge outlet.

7. The assembly of claim 1, further including a second chamber opening, the second chamber opening disposed adjacent to the chamber opening, the second chamber further configured to be in communication with the chamber opening and the outlet conduit.

8. The assembly of claim 1, wherein the flap is hingedly connected to the diversion chamber.

9. The assembly of claim 1, further including a flap compartment.

10. The assembly of claim 9, wherein the flap is configured to position in the flap compartment when fully disengaged and uncovering the chamber opening.

11. The assembly of claim 1, further including a routing notch, the routing notch configured to direct the fluid towards the chamber opening.

12. The assembly of claim 1, wherein the second end of the cable comprises a ring.

13. The assembly of claim 1, wherein the magnet comprises a spring-biased button, the spring-biased button configured to selectively displace the magnet proximally and distally in relation to the flap.

14. The assembly of claim 1, wherein the at least one pressure hole of the pressure chamber comprises a first pressure hole beneath the flap, and a second pressure hole adjacent to the chamber opening.

15. The assembly of claim 1, wherein the pressure chamber further comprises a check valve.

16. A plumbing fixture diversion assembly, the assembly comprising:
an inlet conduit, the inlet conduit configured to enable carrying a fluid;
a diversion chamber, the diversion chamber configured to be in communication with the inlet conduit, the diversion chamber further configured to receive the fluid from the inlet conduit, whereby a substantial volume of the diversion chamber is configured to be filled with the fluid, the diversion chamber comprising a chamber opening;
an outlet conduit, the outlet conduit configured to be in communication with the diversion chamber through the chamber opening, the outlet conduit further configured to discharge the fluid received from the diversion chamber;
a flap, the flap configured to be at least partially fabricated from a metal, the flap further configured to selectively cover and uncover the chamber opening, the flap further configured to require an initial force to at least partially urge the flap towards the chamber opening for covering the chamber opening,
whereby, after the initial force is applied to the flap, the fluid fills a substantial volume of the diversion chamber, creating sufficient fluid pressure in the diversion chamber to displace the flap to cover the first chamber opening,
whereby, after the diversion chamber is filled to a substantial volume with the fluid, the fluid is restricted from flowing into the diversion chamber, causing fluid pressure in the diversion chamber to decrease, causing the flap to disengage and uncover the chamber opening;
a cable, the cable defined by a first end and a second end, the first end of the cable configured to operatively join with the flap, the second end of the cable configured to hang freely from the outlet conduit, the cable configured to apply the initial force to the flap that at least partially urges the flap towards the chamber opening; and
a magnet, the magnet configured to be displaced proximally to the flap, the proximal positioning between the magnet and the flap generating a magnetic force, the magnet force operable to at least partially urge the flap towards the chamber opening.

17. The assembly of claim 16, further including a pressure chamber, the pressure chamber disposed in communication with the diversion chamber through at least one pressure hole, the pressure chamber configured to generate a vacuum by covering and uncovering the at least one pressure hole, the vacuum operable to at least partially urge the flap towards the chamber opening.

18. A plumbing fixture diversion assembly, the assembly comprising:
an inlet conduit, the inlet conduit configured to enable carrying a fluid;
a diversion chamber, the diversion chamber configured to be in communication with the inlet conduit, the diversion chamber further configured to receive the fluid from the inlet conduit, whereby a substantial volume of the diversion chamber is configured to be filled with the fluid, the diversion chamber comprising a chamber opening;
an outlet conduit, the outlet conduit configured to be in communication with the diversion chamber through the chamber opening, the outlet conduit further configured to discharge the fluid received from the diversion chamber;
a flap, the flap configured to be at least partially fabricated from a metal, the flap further configured to selectively cover and uncover the chamber opening, the flap further configured to require an initial force to at least partially urge the flap towards the chamber opening for covering the chamber opening,
whereby, after the initial force is applied to the flap, the fluid fills a substantial volume of the diversion chamber, creating sufficient fluid pressure in the diversion chamber to displace the flap to cover the first chamber opening,
whereby, after the diversion chamber is filled to a substantial volume with the fluid, the fluid is restricted from flowing into the diversion chamber, causing fluid pressure in the diversion chamber to decrease, causing the flap to disengage and uncover the chamber opening; and
a cable, the cable defined by a first end and a second end, the first end of the cable configured to operatively join with the flap, the second end of the cable configured to hang freely from the outlet conduit, the cable configured to apply the initial force to the flap that at least partially urges the flap towards the chamber opening.

19. The assembly of claim 18, further including a magnet, the magnet configured to be displaced proximally to the flap, the proximal positioning between the magnet and the flap generating a magnetic force, the magnet force operable to at least partially urge the flap towards the chamber opening.

20. The assembly of claim 19, further including a pressure chamber, the pressure chamber disposed in communication with the diversion chamber through at least one pressure hole, the pressure chamber configured to generate a vacuum by covering and uncovering the at least one pressure hole, the vacuum operable to at least partially urge the flap towards the chamber opening.
